(19) United States
(12) Patent Application Publication
(10) Pub. No.: US 2025/0086505 A1
(43) Pub. Date: Mar. 13, 2025

(54) MULTIPLE-VALUED LABEL LEARNING FOR TARGET NOMINATION

(71) Applicant: Benson Hill Holdings, Inc., St. Louis, MO (US)

(72) Inventors: Christopher Cotter, St. Louis, MO (US); David Larson, St. Louis, MO (US); Mitchell Goist, St. Louis, MO (US)

(21) Appl. No.: 18/725,407

(22) PCT Filed: Dec. 30, 2022
(86) PCT No.: PCT/US2022/054403

§ 371 Date: Jun. 28, 2024

Related U.S. Application Data
(60) Provisional application No. 63/295,680, filed on Dec. 31, 2021.

(51) Int. Cl. G06N 20/00; G06Q 50/02

(52) U.S. Cl. CPC G06N 20/00; G06Q 50/02

(57) ABSTRACT

A system for generating training data for a machine learning target prioritization model includes a processor and a memory having computer executable instructions stored thereon. The computer executable instructions are configured for execution by the processor to: cause the processor to receive rules linking a candidate targets to a goal, where the rules are incomplete, biased, and/or partially incorrect, cause the processor to generate voters, where each voter is associated with a corresponding rule and each voter contains the logic of each corresponding rule, cause the processor to assign, via each one of the voters, at least one of an association value or an abstention to each one of the candidate targets, and cause the processor to create a single training label for each one of the candidate targets having at least one association value by combining the association values assigned to each respective candidate target.

### BACKGROUND

The term “machine learning” generally refers to the use of computer systems that can learn without following explicit instructions, e.g., using algorithms and models to analyze and draw inferences from data patterns.

### DRAWINGS

The Detailed Description is described with reference to the accompanying figures. The use of the same reference numbers in different instances in the description and the figures may indicate similar or identical items.

FIG. 1 is a block diagram illustrating a system for generating training data for a machine learning target prioritization model in accordance with example embodiments of the present disclosure.

FIG. 2 is a flow diagram illustrating a process for generating training data for a machine learning target prioritization model in accordance with example embodiments of the present disclosure.

FIG. 3 is a diagrammatic illustration of a number of different data sources, where heuristic and/or algorithmic rules that are incomplete but better than a random guess are applied, with logic for a voter in accordance with example embodiments of the present disclosure.

FIG. 4 is a diagrammatic illustration of multiple-instance learning (MIL) loss as used to train a machine learning model on inexact gene-trait associations in accordance with example embodiments of the present disclosure.

FIG. 5 is a diagrammatic illustration of learning true labels from multiple-valued label sources in accordance with example embodiments of the present disclosure.

FIG. 6 is a diagrammatic illustration of the use of noisy, biased, correlated, incomplete, and/or approximate labels to generate gene-target predictions in accordance with example embodiments of the present disclosure.

FIG. 7 is a diagrammatic illustration of multiple-valued labels used to approximate labeled data for a machine learning target prioritization model in accordance with example embodiments of the present disclosure.

FIG. 8 is a diagrammatic illustration of approximated labels used with machine learning modeling paradigms in accordance with example embodiments of the present disclosure.

### DETAILED DESCRIPTION

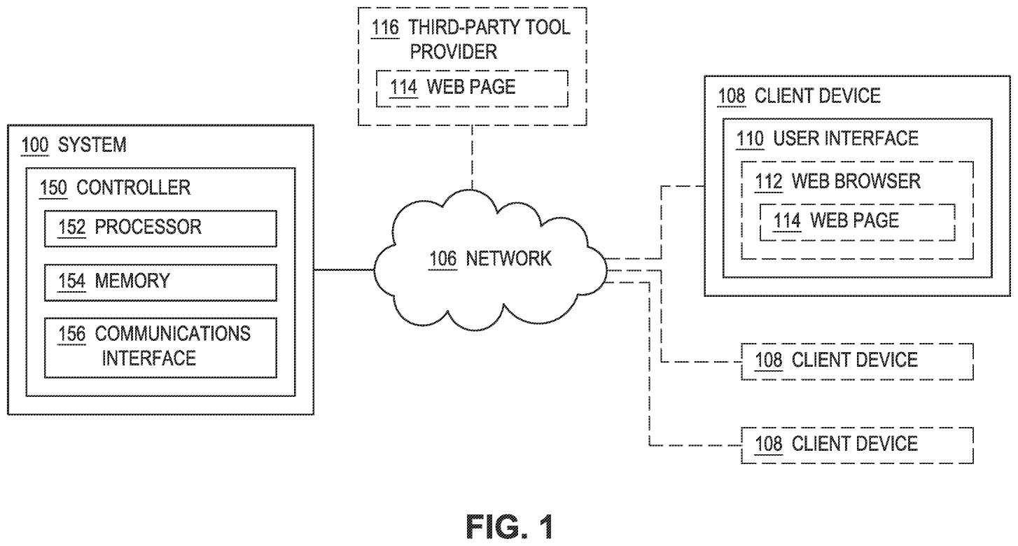

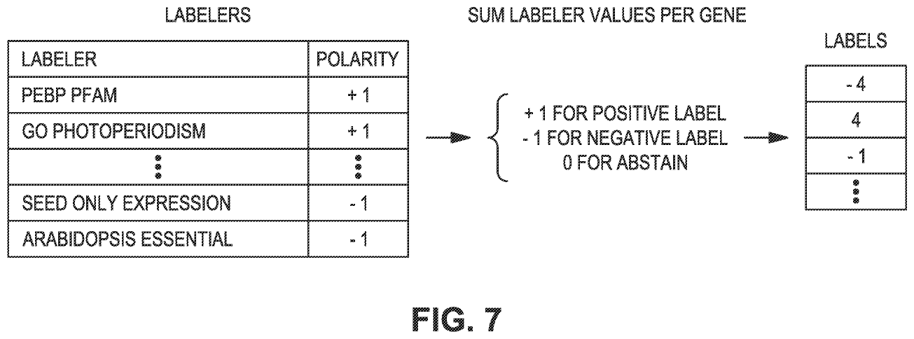

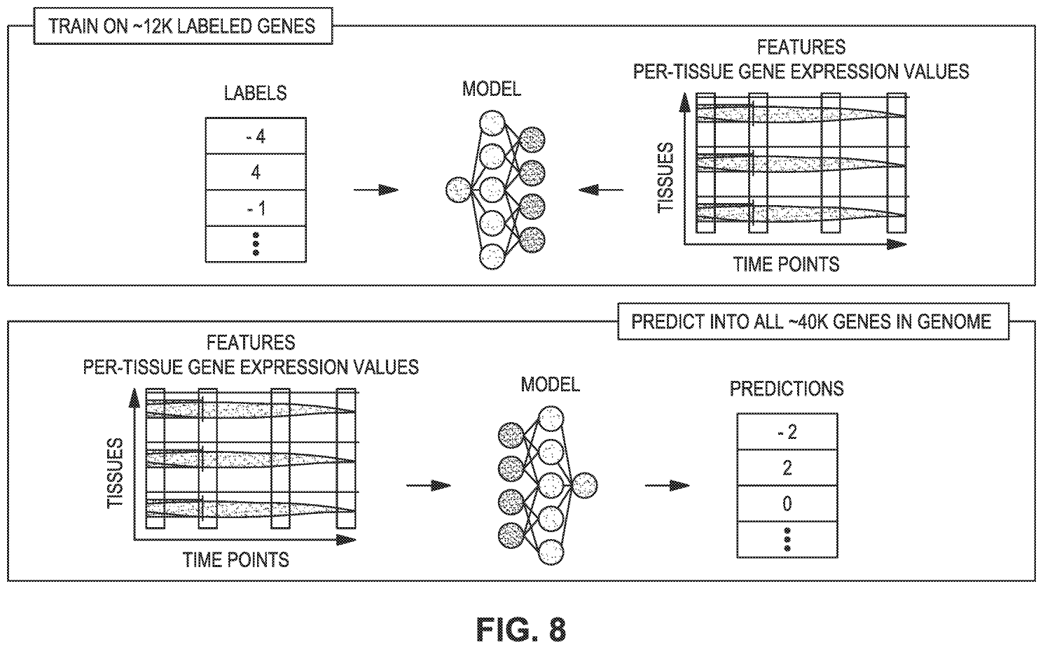

Referring generally to FIGS. 1 through 8, systems 100 are described that provide a framework for combining multiple sources of noisy and/or incomplete information to generate training data for a machine learning target prioritization model. In embodiments of the disclosure, the systems 100 can be used with training data that does not necessarily include any known ground truth targets. For the purposes of the present disclosure, the term “ground truth” shall be understood to refer to information that is considered to be a fact, or is known to be true from direct observation and/or measurement. Targets for machine learning models as described herein can include, but are not necessarily limited to: genes and/or drugs associated with a trait or disease. It should be noted that the techniques described herein can be goal agnostic.

For machine learning models, typical target identification approaches are not predictive under realistic conditions. For example, clustering can be used to generate clusters in which genes share similar functions. However, clusters are generally not objective specific, and it is generally unclear how to choose clusters and/or rank genes in the clusters. Network generation/fusion can be used to generate and/or fuse networks to identify functional links between genes, metabolites, transcripts, and so forth. However, it is generally unclear how to nominate genes from a network (e.g., without training data). It is also generally unclear how to define edges. Prediction/imputation can use multiple data views as features for training a model to predict associations between a target and genes. However, known gene-trait training data is generally required.

In contrast to target discovery that relies on ad-hoc techniques or large amounts of ground truth data to integrate multiple data sources into a single prediction per target, the systems, techniques, and apparatus of the present disclosure leverage multiple-valued label learning (e.g., fuzzy label learning, weak label learning) techniques and programmatically generate labels to generate training data for machine learning models in the absence of the ground truth data that would otherwise be needed to train such models. As described herein, multiple-valued label learning for target nomination provides for target discovery in instances where there is little or no ground truth data. These techniques can also be used to integrate multiple, often dissimilar, and noisy data sources into a single target ranking scheme. Moreover, multiple-valued label learning as described herein can be scaled to new data sources, targets, and/or goals.

As used herein, the term “multiple-valued” as applied to label learning shall be understood to refer to labels and/or variables that can have multiple (e.g., many) values. For example, in the case of a truth value, a variable may have values ranging from completely false to completely true (e.g., ranging from zero (0) to one (1) on a continuum). In another example, non-numerical values (e.g., linguistic values) can be used to express rules and/or facts. Linguistic values may also be modified using adjectives, adverbs, and so forth, e.g., to expand the value scale. In this manner, multiple-valued labels can be used to represent imprecise and/or non-numerical information, i.e., as a mathematical model of vagueness. In some embodiments, machine learning systems, techniques, and apparatus as described herein may use these multiple-valued labels by representing supervision as a multiple-valued set over a collection of possible classification labels.

The systems 100 described herein can be used with techniques for multiple-valued supervision, semi-supervised learning, multiple-instance learning, multiple-valued labels, programmatically generated labels, gene/genomic target identification and/or prioritization, drug target identification and/or prioritization, and so forth. As described, multiple-valued label learning that integrates multiple data sources can generate better predictions than any one independent data source. Additionally, generating ground truth data sets large enough to train complex target prioritization models may be prohibitively expensive, especially in biological domains. Thus, the systems, techniques, and apparatus of the present disclosure can provide accurate target prioritization models and decrease research and development costs by reducing the candidate target search space, e.g., by one hundred times or more in some examples.

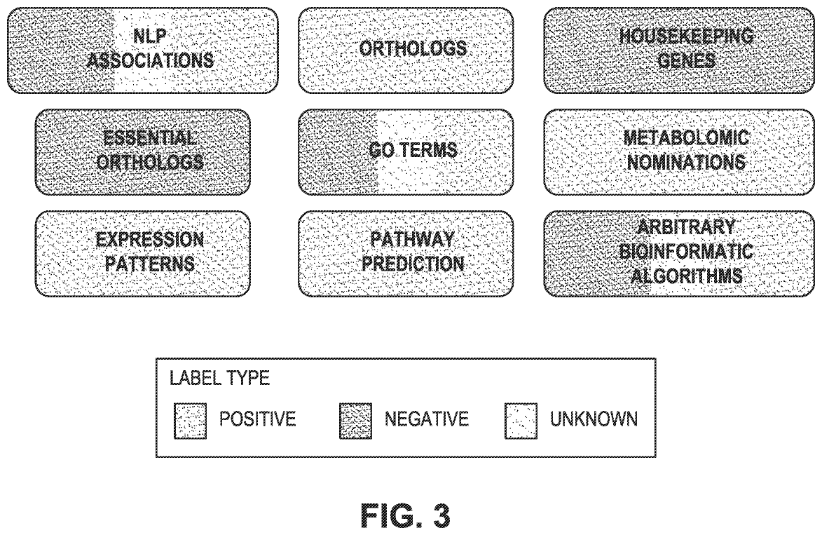

Systems 100 can generate training data for a machine learning target prioritization model. As described, a system 100 receives rules that link candidate targets to a goal, where one or more of the rules are incomplete, biased, and/or partially incorrect, but provide at least multiple-value type information about the association of a candidate target with the goal. The rules can be generated heuristically, algorithmically, and so forth. In some embodiments, the rules are generated using all available data linking the candidate targets to the goal. The system 100 includes a controller 150 configured to generate voters, where each voter is associated with a corresponding rule, and each voter contains the logic of the corresponding rule. The controller 150 is configured to assign, via each one of the voters, an association value or an abstention to each one of the candidate targets. In some embodiments, the association values can be positive and unlabeled, while in other examples, the association values can be positive and negative. Examples of negative association values include, but are not necessarily limited to: genes with a mutant phenotype, genes associated with traits that are of little or no interest, and so forth. With reference to FIG. 3, positive, negative, and unknown association values can be assigned to a number of different data sources. In another example, only positive association values are assigned to data sources, such as genome-wide association studies (GWAS), mutant libraries, and published quantitative trait locus (QTL) data.

Then, for each one of the candidate targets having at least one association value (i.e., at least one non-abstain vote), the controller 150 creates a single training label by combining the association values assigned to each respective candidate target. The controller 150 is configured to furnish the candidate targets and associated single training labels for use by a machine learning model. The single training labels can be used to train the machine learning model. In embodiments of the disclosure, features of the machine learning model can include all available data for the candidate targets, including the data used to generate the voters and the voter association values. The trained machine learning model can be used to predict the strength of association between each candidate target and the goal. Candidate targets with the highest predicted associations are high priority candidates for targeted modification to influence the goal.

Systems 100 can also be used to train machine learning models on target nomination methods that generate loci subsets. As described, a system 100 can train a machine learning model on results from loci target nominations that produce one or more loci subsets. For the purposes of the present disclosure, a loci subset shall be assumed to have at least one true target. However, which loci in the subset is the true target shall be understood to be unknown. For the purposes of the present disclosure, each subset may also be referred to as a bag. Typically, machine learning models trained using data sets that contain subsetted groups or bags of instances require assumptions about the subset generating process. In contrast, the systems, techniques, and apparatus described herein can use multiple-instance learning with data sets in a machine learning framework that allows the subsetted data sets to be included without assumptions about the subset generating process, and in a variety of machine learning frameworks.

In embodiments of the disclosure, multiple public and private data sets (e.g., GWAS, QTL, mutant libraries, and so forth) can be used in a machine learning-driven gene target nomination process. For example, using multiple-instance learning, a gene target discriminator, s, can be trained. In an example embodiment, the probability that at least one gene associated with a single training label, such as a GWAS peak, is a target gene can be described as follows:

$$p ( S contains a target gene \vert {S}_{{g}_{1} , … , {g}_{n}} ) = 1 - {\prod }_{j} ( 1 - σ ( {g}_{j} ) )$$

where Sᵢ={g₁, . . . , gₙ} is a collection of genes, yᵢ is the label of i, and s is a discriminative model, such that s(g)=p(g is a target gene). Similarly, the probability that no genes associated with a single training label, such as the GWAS peak, are a target can be described as follows:

$$p ( S does not contain a target gene \vert {S}_{{g}_{1} , … , {g}_{n}} ) = {\prod }_{j} ( 1 - σ ( {g}_{j} ) )$$

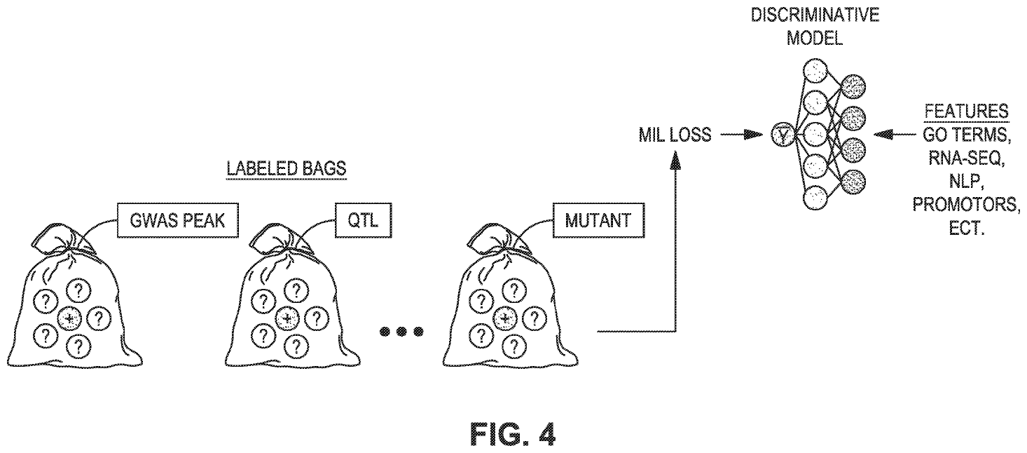

With reference to FIG. 4, multiple-instance learning loss can be used to train a machine learning model on inexact gene-trait associations. For example, multiple single training labels, each having a combination of association values, and each including at least one positive gene or association value, are arranged in sets (also called bags) and supplied to one or more multiple-instance learning loss functions, which are then used to train a discriminative model. Examples of single training labels can include, but are not necessarily limited to: a GWAS peak, a QTL, a mutant, and so forth. As described, features including, but not necessarily limited to: gene ontology (GO) terms, ribonucleic acid (RNA) sequences, natural language processing (NLP), promotors, and so forth can also be used to train the discriminative model.

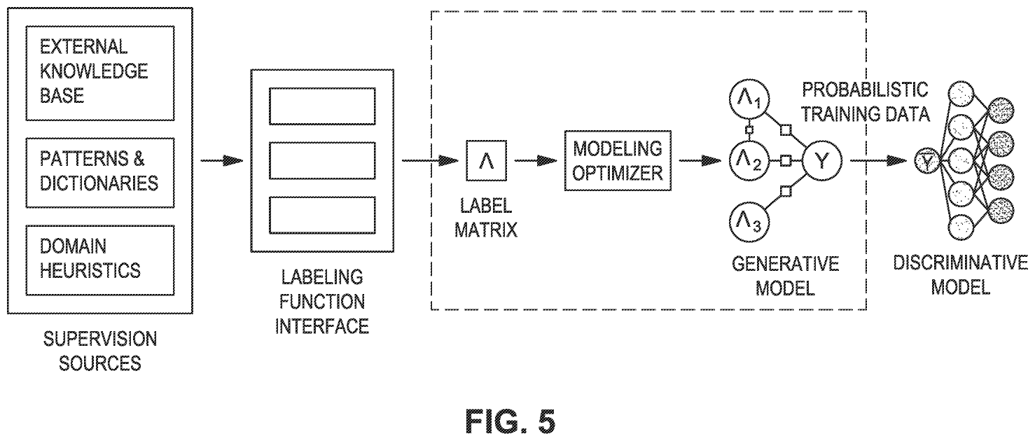

With reference to FIG. 5, true or more accurate labels can be learned by supplying information from one or more multiple-valued supervision sources to a labeling function interface, and then to a library configured to programmatically build and manage training datasets. In this manner, systems 100 can be used to facilitate at least partial automation of data label creation. For example, supervision sources, such as external knowledge bases, patterns and dictionaries, domain heuristics, and so forth can be used to encode rules for labeling data into a labeling function, which is accessible via a labeling function interface. Using the labeling function interface, automated candidate labels can be generated, which can then be supplied to a library configured to programmatically build and manage training datasets. Information from the library can be supplied to a discriminative model, used to iteratively improve the labeling functions, provided as feedback to supervision sources, and so forth.

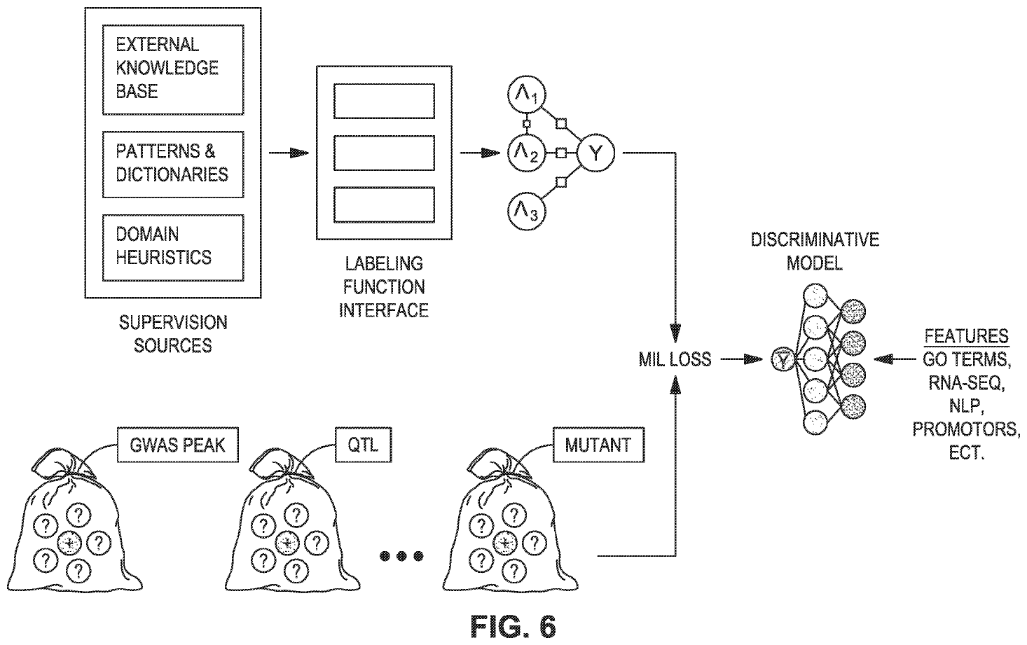

Referring now to FIG. 6, in some embodiments MIL loss may be reduced to binary cross entropy (BCE) loss, e.g., where multiple single training labels are arranged in sets or bags that each include only one positive gene or association value. For instance, the following representation of MIL loss,

$${y}_{i} log [ 1 - {\prod }_{j} ( 1 - σ ( {g}_{i} ) ) ] + ( 1 - {y}_{i} ) log [ {\prod }_{j} ( 1 - σ ( {g}_{i} ) ) ]$$

may be reduced to the following representation of BCE loss.

$${y}_{i} log [ σ ( {g}_{i} ) ] + ( 1 - {y}_{i} ) log [ 1 - σ ( {g}_{i} ) ]$$

when each set or bag of single training labels includes only one gene or multiple-valued label. In this manner, multiple-instance training can be augmented with directly labeled instances. In embodiments of the disclosure, this augmentation can be used to generate a data set large enough to train a sufficiently complex model in target nomination settings.

As described herein, the systems, techniques, and apparatus of the present disclosure provide for data flexibility, allowing integration of all typical biological datatypes. Further, the systems 100 described herein are not necessarily dependent upon any particular data types. Additionally, systems 100 are amenable to no or few known gene-trait links, e.g., being constrained by the ability to generate rules and/or multiple-valued labels. Systems 100 can also be implemented with minimal reliance on expert opinion. In some instances, expert opinions can be encouraged for generating multiple-valued labels, and opinions can be double checked by multiple-valued label modeling. In embodiments of the disclosure, heuristics are welcome for generating multiple-valued labels, and multiple-valued label modeling can be used to support the heuristics.

Referring now to FIG. 1, a system 100 can be configured to connect to a network 106 and communicate with one or more client devices 108. The system 100 can also be configured to provide one or more client devices 108 with a user interface 110 for receiving and interacting with information from the system 100. A client device 108 can be an information handling system device, including, but not necessarily limited to: a mobile computing device (e.g., a band-held portable computer, a personal digital assistant (PDA), a laptop computer, a netbook computer, a tablet computer, and so forth), a mobile telephone device (e.g., a cellular telephone, a smartphone), a device that includes functionalities associated with smartphones and tablet computers (e.g., a phablet), a portable game device, a portable media player device, a multimedia device, an e-book reader device (eReader), a smart television (TV) device, a surface computing device (e.g., a table top computer), a personal computer (PC) device, and so forth. However, a user interface 110 is not necessarily provided to a client device 108. Interactivity with a system 100 is also not necessarily provided via a user interface 108. In some embodiments, interactivity with a system 100 can be provided at a system level, e.g., in the form of a list of results, a table of results, and/or another type of electronic file, which may be provided to another system outside of the system 100, to other software executing within a system 100, and so forth.

In some embodiments, a system 100 provides on demand software. e.g., in the manner of software as a service (SaaS) distributed to a client device 108 via the network 106 (e.g., the Internet). For example, a system 100 hosts multiple-valued label learning software and associated data in the cloud, allowing the system 100 to scale, e.g., at an application level, at a data storage level, and so forth. Cloud computing techniques may also be used with systems 100 to allow for duplication of data (e.g., for data redundancy), data security, and so forth. The software is accessed by the client device 108 with a thin client (e.g., via a web browser 112). A user interfaces with the software (e.g., a web page 114) provided by the system 100 via the user interface 110 (e.g., using web browser 112). In embodiments of the disclosure, the system 100 communicates with a client device 108 using an application protocol, such as hypertext transfer protocol (HTTP). In some embodiments, the system 100 provides a client device 108 with a user interface 110 accessed using a web browser 112 and displayed on a monitor and/or a mobile device. Web browser form input can be provided using a hypertext markup language (HTML) and/or extensible HTML (XHTML) format, and can provide navigation to other web pages (e.g., via hypertext links). The web browser 112 can also use other resources such as style sheets, scripts, images, and so forth.

In other embodiments, content is served to a client device 108 using another application protocol. For instance, a third-party tool provider 116 (e.g., a tool provider not operated and/or maintained by a system 100) can include content from a system 100 (e.g., embedded in a web page 114 provided by the third-party tool provider 116). It should be noted that a thin client configuration for the client device 108 is provided by way of example only and is not meant to limit the present disclosure. In other embodiments, the client device 108 is implemented as a thicker (e.g., fat, heavy, rich) client. For example, the client device 108 provides rich functionality independently of the system 100. In some embodiments, one or more cryptographic protocols are used to transmit information between a system 100 and a client device 108 and/or a third-party tool provider 116. Examples of such cryptographic protocols include, but are not necessarily limited to: a transport layer security (TLS) protocol, a secure sockets layer (SSL) protocol, and so forth. For instance, communications between a system 100 and a client device 108 can use HTTP secure (HTTPS) protocol, where HTTP protocol is layered on SSL and/or TLS protocol.

Techniques in accordance with the present disclosure can be used to implement cloud-based systems. For the purposes of the present disclosure, the terms cloud-based and cloud computing are used to refer to a variety of computing concepts, generally involving a large number of computers connected through a real-time communication network, such as the Internet. However, cloud computing is provided by way of example and is not meant to limit the present disclosure. The techniques described herein can be used in various computing environments and architectures, including, but not necessarily limited to: client-server architectures where distributed applications are implemented by service providers (servers) and service requesters (clients), peer-to-peer architectures where participants are both suppliers and consumers of resources, and so forth.

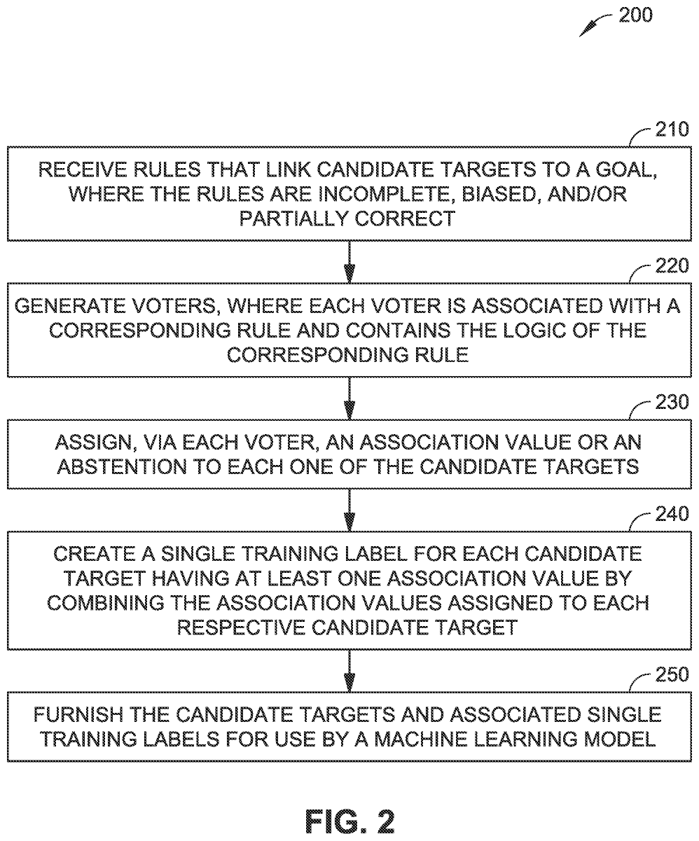

The following discussion describes example techniques for generating training data for a machine learning target prioritization model. FIG. 2 depicts a process 200, in accordance with example embodiments, for generating training data for a machine learning target prioritization model using a system, such as the system 100 illustrated in FIG. 1 and described above. In the process illustrated, rules that link candidate targets to a goal are received, where one or more of the rules are incomplete, biased, and/or partially incorrect (Block 210). As described with reference to FIG. 3, the rules provide at least multiple-value type information (e.g., positive, negative, unknown) about the association of a candidate target with the goal. The rules can be generated heuristically, algorithmically, and so forth. In some embodiments, the rules are generated using all available data linking the candidate targets to the goal.

Then, voters are generated, where each voter is associated with a corresponding rule, and each voter contains the logic of the corresponding rule (Block 220). Next, each one of the voters assigns an association value or an abstention to each one of the candidate targets (Block 230). Then, a single training label is created for each candidate target having at least one association value by combining the association values assigned to each respective candidate target (Block 240). Next, the candidate targets and associated single training labels are furnished for use by a machine learning model (Block 250). As described, features of the machine learning model can include all available data for the candidate targets, including the data used to generate the voters and the voter association values. Then, the trained machine learning model can be used to predict the strength of association between each candidate target and the goal. Candidate targets with the highest predicted associations are high priority candidates for targeted modification to influence the goal.

In some embodiments, the machine learning model can be trained to rank or classify loci for an effect on a candidate target (e.g., target trait). For example, one or more loci subsets associated with candidate targets are furnished to a machine learning model along with the candidate targets and associated single training labels. In example embodiments, subsets of loci are identified, where at least one locus in each loci subset is assumed to be associated with a candidate target. Examples include, but are not necessarily limited to: GWAS (e.g., where each peak contains a subset of loci), QTL (e.g., where each locus contains a subset of loci), mutant libraries (e.g., where each plant contains a subset of loci with mutations), and so forth. In some examples, the training set for the machine learning model uses entirely nominated loci subsets. In some embodiments, the loci subsets are augmented by other directly labeled loci (e.g., as previously described). The machine learning model can be trained on both the loci subsets (e.g., using multiple-instance learning to train a target discriminator) and the directly labeled loci. For instance, the subsetted and directly labeled loci are combined during training using binary cross entropy. As described, the trained machine learning model can be used to rank or classify the loci for an effect on the candidate target (e.g., target trait)

In accordance with the present disclosure, the systems, techniques, and apparatus described herein can be used to confer desired traits to agricultural products, such as plants, including, but not necessarily limited to: soybean plants and yellow pea plants. In embodiments of the disclosure, a candidate target can be a gene associated with a crop performance of an agricultural product (e.g., how well plants grow, overall yield), a trait of an agricultural product (e.g., protein concentrate produced from plants, such as white flake from soybean plants), and so forth. For example, the trait of the agricultural product can be selected to increase or enhance one or more of a protein content of the agricultural product, a flavor of the agricultural product, a nutrition of the agricultural product, and so forth. As described, such improvements to the agricultural product can be improvements to a crop, grain from a crop, food products derived from plant products produced by a population of plants bred using the systems, techniques, and apparatus described herein, and so on. In this manner, systems 100 can be used to select genes to improve soybeans, peas, and/or other crops, e.g., in their capacity to make food that is more nutritious, flavorful, and/or healthy. Further, the techniques disclosed herein can increase the efficiency of choosing or selecting such genes.

Methods disclosed herein include conferring desired traits to plants, for example, by mutating sequences of a plant, introducing nucleic acids into plants, using plant breeding techniques and various crossing schemes, etc. These methods are not limited as to certain mechanisms of how the plant exhibits and/or expresses the desired trait. In certain nonlimiting embodiments, the trait is conferred to the plant by introducing a nucleotide sequence (e.g. using plant transformation methods) that encodes production of a certain protein by the plant. In certain nonlimiting embodiments, the desired trait is conferred to a plant by causing a null mutation in the plant's genome (e.g. when the desired trait is reduced expression or no expression of a certain trait). In certain nonlimiting embodiments, the desired trait is conferred to a plant by crossing two plants to create offspring that express the desired trait. It is expected that users of these teachings will employ a broad range of techniques and mechanisms known to bring about the expression of a desired trait in a plant. Thus, as used herein, conferring a desired trait to a plant is meant to include any process that causes a plant to exhibit a desired trait, regardless of the specific techniques employed.

As used herein, a “mutation” is any change in a nucleic acid sequence. Nonlimiting examples comprise insertions, deletions, duplications, substitutions, inversions, and translocations of any nucleic acid sequence, regardless of how the mutation is brought about and regardless of how or whether the mutation alters the functions or interactions of the nucleic acid. For example and without limitation, a mutation may produce altered enzymatic activity of a ribozyme, altered base pairing between nucleic acids (e.g. RNA interference interactions, DNA-RNA binding, etc.), altered mRNA folding stability, and/or how a nucleic acid interacts with polypeptides (e.g. DNA-transcription factor interactions. RNA-ribosome interactions, gRNA-endonuclease reactions, etc.). A mutation might result in the production of proteins with altered amino acid sequences (e.g. missense mutations, nonsense mutations, frameshift mutations, etc.) and/or the production of proteins with the same amino acid sequence (e.g. silent mutations). Certain synonymous mutations may create no observed change in the plant while others that encode for an identical protein sequence nevertheless result in an altered plant phenotype (e.g. due to codon usage bias, altered secondary protein structures, etc.). Mutations may occur within coding regions (e.g., open reading frames) or outside of coding regions (e.g., within promoters, terminators, untranslated elements, or enhancers), and may affect, for example and without limitation, gene expression levels, gene expression profiles, protein sequences, and/or sequences encoding RNA elements such as tRNAs, ribozymes, ribosome components, and microRNAs.

Methods disclosed herein are not limited to mutations made in the genomic DNA of the plant nucleus. For example, in certain embodiments a mutation is created in the genomic DNA of an organelle (e.g. a plastid and/or a mitochondrion). In certain embodiments, a mutation is created in extrachromosomal nucleic acids (including RNA) of the plant, cell, or organelle of a plant. Nonlimiting examples include creating mutations in supernumerary chromosomes (e.g. B chromosomes), plasmids, and/or vector constructs used to deliver nucleic acids to a plant. It is anticipated that new nucleic acid forms will be developed and yet fall within the scope of the claimed invention when used with the teachings described herein.

Methods disclosed herein are not limited to certain techniques of mutagenesis. Any method of creating a change in a nucleic acid of a plant can be used in conjunction with the disclosed invention, including the use of chemical mutagens (e.g. methanesulfonate, sodium azide, aminopurine, etc.), genome/gene editing techniques (e.g. CRISPR-like technologies, TALENs, zinc finger nucleases, and meganucleases), ionizing radiation (e.g. ultraviolet and/or gamma rays) temperature alterations, long-term seed storage, tissue culture conditions, targeting induced local lesions in a genome, sequence-targeted and/or random recombinases, etc. It is anticipated that new methods of creating a mutation in a nucleic acid of a plant will be developed and yet fall within the scope of the claimed invention when used with the teachings described herein.

Similarly, the embodiments disclosed herein are not limited to certain methods of introducing nucleic acids into a plant and are not limited to certain forms or structures that the introduced nucleic acids take. Any method of transforming a cell of a plant described herein with nucleic acids are also incorporated into the teachings of this innovation, and one of ordinary skill in the art will realize that the use of particle bombardment (e.g. using a gene-gun), Agrobacterium infection and/or infection by other bacterial species capable of transferring DNA into plants (e.g., Ochrobactrum sp., Ensifer sp., Rhizobium sp.), viral infection, and other techniques can be used to deliver nucleic acid sequences into a plant described herein. Methods disclosed herein are not limited to any size of nucleic acid sequences that are introduced, and thus one could introduce a nucleic acid comprising a single nucleotide (e.g. an insertion) into a nucleic acid of the plant and still be within the teachings described herein. Nucleic acids introduced in substantially any useful form, for example, on supernumerary chromosomes (e.g. B chromosomes), plasmids, vector constructs, additional genomic chromosomes (e.g. substitution lines), and other forms is also anticipated. It is envisioned that new methods of introducing nucleic acids into plants and new forms or structures of nucleic acids will be discovered and yet fall within the scope of the claimed invention when used with the teachings described herein.

In certain embodiments, a user can combine the teachings herein with high-density molecular marker profiles spanning substantially the entire soybean genome to estimate the value of selecting certain candidates in a breeding program in a process commonly known as genome selection.

In certain embodiments, plants disclosed herein can be modified to exhibit at least one desired trait, and/or combinations thereof. The disclosed innovations are not limited to any set of traits that can be considered desirable, but nonlimiting examples include male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, modified water use efficiency, and/or combinations thereof. Desired traits can also include traits that are deleterious to plant performance, for example, when a researcher desires that a plant exhibits such a trait in order to study its effects on plant performance.

As used herein, “fertilization” and/or “crossing” broadly includes bringing the genomes of gametes together to form zygotes but also broadly may include pollination, syngamy, fecundation and other processes related to sexual reproduction. Typically, a cross and/or fertilization occurs after pollen is transferred from one flower to another, but those of ordinary skill in the art will understand that plant breeders can leverage their understanding of fertilization and the overlapping steps of crossing, pollination, syngamy, and fecundation to circumvent certain steps of the plant life cycle and yet achieve equivalent outcomes, for example, a plant or cell of a soybean cultivar described herein. In certain embodiments, a user of this innovation can generate a plant of the claimed invention by removing a genome from its host gamete cell before syngamy and inserting it into the nucleus of another cell. While this variation avoids the unnecessary steps of pollination and syngamy and produces a cell that may not satisfy certain definitions of a zygote, the process falls within the definition of fertilization and/or crossing as used herein when performed in conjunction with these teachings. In certain embodiments, the gametes are not different cell types (i.e. egg vs. sperm), but rather the same type and techniques are used to effect the combination of their genomes into a regenerable cell. Other embodiments of fertilization and/or crossing include circumstances where the gametes originate from the same parent plant. i.e. a “self” or “self-fertilization”. While selfing a plant does not require the transfer pollen from one plant to another, those of skill in the art will recognize that it nevertheless serves as an example of a cross, just as it serves as a type of fertilization. Thus, methods and compositions taught herein are not limited to certain techniques or steps that must be performed to create a plant or an offspring plant of the claimed invention, but rather include broadly any method that is substantially the same and/or results in compositions of the claimed invention.

A plant refers to a whole plant, any part thereof, or a cell or tissue culture derived from a plant, comprising any of: whole plants, plant components or organs (e.g., leaves, stems, roots, etc.), plant tissues, seeds, plant cells, protoplasts and/or progeny of the same. A plant cell is a biological cell of a plant, taken from a plant or derived through culture of a cell taken from a plant.

The teachings herein are not limited to certain plant species, and it is envisioned that they can be modified to be useful for monocots, dicots, and/or substantially any crop and/or valuable plant type, including plants that can reproduce by self-fertilization and/or cross fertilization, hybrids, inbreds, varieties, and/or cultivars thereof. Some of example plant species include, soybeans (Glycine max), peas (Pisum sativum and other members of the Fabaceae like C janus and Vigna species), chickpeas (Cicer arietinum), peanuts (Arachis hypogaea), lentils (Lens culinaris or Lens esculenta), lupins (various Lupinus species), mesquite (various Proopis species), clover (various Trifolium species), carob (Ceratonia siliqua), tamarind, corn (Zea mays), Brassica sp. (e.g. B. napus, B. rapa. B. juncea), particularly those Brassica species useful as sources of seed oil, alfalfa (Medicago sativa), rice (Oryza sativa), rye (Secale cereale), sorghum (Sorghum bicolor, Sorghum vulgare), camelina (Camelina sativa), millet (e.g., pearl millet (Pennisetum glaucum), proso millet (Panicum miliaceum), foxtail millet (Setaria italica), finger millet (Eleusine coracana)), sunflower (Helianthus annuus), quinoa (Chenopodium quinoa), chicory (Cichorium intybus), tomato (Solanum lycopersicum), lettuce (Lactuca sativa), safflower (Carthamus tinctorius), wheat (Triticum aestivum), tobacco (Nicotiana tabacum), potato (Solanum tuberosum), peanuts (Arachis hypogaea), cotton (Gossypium barbadense. Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oil palm (Elaeis guineensis), poplar (Populus spp.), eucalyptus (Eucalyptus spp.), oats (Avena sativa), barley (Hordeum vulgare), flax (Linum usitatissimum), Buckwheat (Fagopyrum esculentum) vegetables, ornamentals, and conifers.

A population means a set comprising any number, including one, of individuals, objects, or data from which samples are taken for evaluation, e.g. estimating QTL effects and/or disease tolerance. Most commonly, the terms relate to a breeding population of plants from which members are selected and crossed to produce progeny in a breeding program. A population of plants can include the progeny of a single breeding cross or a plurality of breeding crosses and can be either actual plants or plant derived material, or in silico representations of plants. The member of a population need not be identical to the population members selected for use in subsequent cycles of analyses nor does it need to be identical to those population members ultimately selected to obtain a final progeny of plants. Often, a plant population is derived from a single biparental cross but can also derive from two or more crosses between the same or different parents. Although a population of plants can comprise any number of individuals, those of skill in the art will recognize that plant breeders commonly use population sizes ranging from one or two hundred individuals to several thousand, and that the highest performing 5-20% of a population is what is commonly selected to be used in subsequent crosses in order to improve the performance of subsequent generations of the population in a plant breeding program.

Crop performance is used synonymously with plant performance and refers to how well a plant grows under a set of environmental conditions and cultivation practices. Crop performance can be measured by any metric a user associates with a crop's productivity (e.g. yield), appearance and/or robustness (e.g. color, morphology, height, biomass, maturation rate), product quality (e.g. fiber lint percent, fiber quality, seed protein content, seed carbohydrate content, etc.), cost of goods sold (e.g. the cost of creating a seed, plant, or plant product in a commercial, research, or industrial setting) and/or a plant's tolerance to disease (e.g. a response associated with deliberate or spontaneous infection by a pathogen) and/or environmental stress (e.g. drought, flooding, low nitrogen or other soil nutrients, wind, hail, temperature, day length, etc.). Crop performance can also be measured by determining a crop's commercial value and/or by determining the likelihood that a particular inbred, hybrid, or variety will become a commercial product, and/or by determining the likelihood that the offspring of an inbred, hybrid, or variety will become a commercial product. Crop performance can be a quantity (e.g. the volume or weight of seed or other plant product measured in liters or grams) or some other metric assigned to some aspect of a plant that can be represented on a scale (e.g. assigning a 1-10 value to a plant based on its disease tolerance).

A microbe will be understood to be a microorganism. i.e. a microscopic organism, which can be single celled or multicellular. Microorganisms are very diverse and include all the bacteria, archaea, protozoa, fungi, and algae, especially cells of plant pathogens and/or plant symbionts. Certain animals are also considered microbes, e.g. rotifers. In various embodiments, a microbe can be any of several different microscopic stages of a plant or animal. Microbes also include viruses, viroids, and prions, especially those which are pathogens or symbionts to crop plants.

A fungus includes any cell or tissue derived from a fungus, for example whole fungus, fungus components, organs, spores, hyphae, mycelium, and/or progeny of the same. A fungus cell is a biological cell of a fungus, taken from a fungus or derived through culture of a cell taken from a fungus.

A pest is any organism that can affect the performance of a plant in an undesirable way. Common pests include microbes, animals (e.g. insects and other herbivores), and/or plants (e.g. weeds). Thus, a pesticide is any substance that reduces the survivability and/or reproduction of a pest, e.g. fungicides, bactericides, insecticides, herbicides, and other toxins.

Tolerance or improved tolerance in a plant to disease conditions (e.g. growing in the presence of a pest) will be understood to mean an indication that the plant is less affected by the presence of pests and/or disease conditions with respect to yield, survivability and/or other relevant agronomic measures, compared to a less tolerant, more “susceptible” plant. Tolerance is a relative term, indicating that a “tolerant” plant survives and/or performs better in the presence of pests and/or disease conditions compared to other (less tolerant) plants (e.g., a different soybean cultivar) grown in similar circumstances. As used in the art, tolerance is sometimes used interchangeably with “resistance”, although resistance is sometimes used to indicate that a plant appears maximally tolerant to, or unaffected by, the presence of disease conditions. Plant breeders of ordinary skill in the art will appreciate that plant tolerance levels vary widely, often representing a spectrum of more-tolerant or less-tolerant phenotypes, and are thus trained to determine the relative tolerance of different plants, plant lines or plant families and recognize the phenotypic gradations of tolerance.

A plant, or its environment, can be contacted with a wide variety of “agriculture treatment agents.” As used herein, an “agriculture treatment agent”, or “treatment agent”, or “agent” can refer to any exogenously provided compound that can be brought into contact with a plant tissue (e.g. a seed) or its environment that affects a plant's growth, development and/or performance, including agents that affect other organisms in the plant's environment when those effects subsequently alter a plant's performance, growth, and/or development (e.g. an insecticide that kills plant pathogens in the plant's environment, thereby improving the ability of the plant to tolerate the insect's presence). Agriculture treatment agents also include a broad range of chemicals and/or biological substances that are applied to seeds, in which case they are commonly referred to as seed treatments and/or seed dressings. Seed treatments are commonly applied as either a dry formulation or a wet slurry or liquid formulation prior to planting and, as used herein, generally include any agriculture treatment agent including growth regulators, micronutrients, nitrogen-fixing microbes, and/or inoculants. Agriculture treatment agents include pesticides (e.g. fungicides, insecticides, bactericides, etc.) hormones (abscisic acids, auxins, cytokinins, gibberellins, etc.) herbicides (e.g. glyphosate, atrazine, 2.4-D, dicamba, etc.), nutrients (e.g. a plant fertilizer), and/or a broad range of biological agents, for example a seed treatment inoculant comprising a microbe that improves crop performance, e.g. by promoting germination and/or root development. In certain embodiments, the agriculture treatment agent acts extracellularly within the plant tissue, such as interacting with receptors on the outer cell surface. In some embodiments, the agriculture treatment agent enters cells within the plant tissue. In certain embodiments, the agriculture treatment agent remains on the surface of the plant and/or the soil near the plant. In certain embodiments, the agriculture treatment agent is contained within a liquid. Such liquids include, but are not limited to, solutions, suspensions, emulsions, and colloidal dispersions. In some embodiments, liquids described herein will be of an aqueous nature. However, in various embodiments, such aqueous liquids that comprise water can also comprise water insoluble components, can comprise an insoluble component that is made soluble in water by addition of a surfactant, or can comprise any combination of soluble components and surfactants. In certain embodiments, the application of the agriculture treatment agent is controlled by encapsulating the agent within a coating, or capsule (e.g. microencapsulation). In certain embodiments, the agriculture treatment agent comprises a nanoparticle and/or the application of the agriculture treatment agent comprises the use of nanotechnology.

Referring now to FIG. 1, a system 100, including some or all of its components, can operate under computer control. For example, a processor 150 can be included with or in a system 100 to control the components and functions of systems 100 described herein using software, firmware, hardware (e.g., fixed logic circuitry), manual processing, or a combination thereof. The terms “controller,” “functionality.” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The processor 150 provides processing functionality for the system 100 and can include any number of processors, micro-controllers, or other processing systems, and resident or external memory for storing data and other information accessed or generated by the system 100. The processor 150 can execute one or more software programs that implement techniques described herein. The processor 150 is not limited by the materials from which it is formed or the processing mechanisms employed therein and, as such, can be implemented via semiconductor(s) and/or transistors (e.g., using electronic integrated circuit (IC) components), and so forth.

The system 100 includes a memory 152. The memory 152 is an example of tangible, computer-readable storage medium that provides storage functionality to store various data associated with operation of the system 100, such as software programs and/or code segments, or other data to instruct the processor 150, and possibly other components of the system 100, to perform the functionality described herein. Thus, the memory 152 can store data, such as a program of instructions for operating the system 100 (including its components), and so forth. It should be noted that while a single memory 152 is described, a wide variety of types and combinations of memory (e.g., tangible, non-transitory memory) can be employed. The memory 152 can be integral with the processor 150, can comprise stand-alone memory, or can be a combination of both.

The memory 152 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 152 can include removable integrated circuit card (ICC) memory, such as memory provided by a subscriber identity module (SIM) card, a universal subscriber identity module (USIM) card, a universal integrated circuit card (UICC), and so on.

The system 100 includes a communications interface 154. The communications interface 154 is operatively configured to communicate with components of the system 100. For example, the communications interface 154 can be configured to transmit data for storage in the system 100, retrieve data from storage in the system 100, and so forth. The communications interface 154 is also communicatively coupled with the processor 150 to facilitate data transfer between components of the system 100 and the processor 150 (e.g., for communicating inputs to the processor 150 received from a device communicatively coupled with the system 100). It should be noted that while the communications interface 154 is described as a component of a system 100, one or more components of the communications interface 154 can be implemented as external components communicatively coupled to the system 100 via a wired and/or wireless connection. The system 100 can also comprise and/or connect to one or more input/output (I/O) devices (e.g., via the communications interface 154), including, but not necessarily limited to: a display, a mouse, a touchpad, a keyboard, and so on.

The communications interface 154 and/or the processor 150 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet: the Internet: a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 154 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A system for generating training data for a machine learning target prioritization model, the system comprising:
a processor; and
a memory having computer executable instructions stored thereon, the computer executable instructions configured for execution by the processor to:
cause the processor to receive a plurality of rules linking a plurality of candidate targets to a goal, at least one rule of the plurality of rules being at least one of incomplete, biased, or partially incorrect,
cause the processor to generate a plurality of voters, each one of the plurality of voters associated with a corresponding one of the plurality of rules, each one of the plurality of voters containing logic of each corresponding one of the plurality of rules,
cause the processor to assign, via each one of the plurality of voters, at least one of an association value or an abstention to each one of the plurality of candidate targets,
cause the processor to create a single training label for each one of the plurality of candidate targets having at least one association value by combining the association values assigned to each respective one of the plurality of candidate targets, and
cause the processor to furnish the plurality of candidate targets and associated single training labels for use by a machine learning model.

2. The system as recited in claim 1, wherein the plurality of rules is generated at least one of heuristically or algorithmically.

3. The system as recited in claim 1, wherein the plurality of rules is generated using all available data linking the plurality of candidate targets to the goal.

4. The system as recited in claim 1, wherein the association value is positive and unlabeled.

5. The system as recited in claim 1, wherein the association value is either positive or negative.

6. The system as recited in claim 1, wherein the computer executable instructions are configured for execution by the processor to cause the processor to furnish at least one loci subset associated with the plurality of candidate targets along with the plurality of candidate targets and associated single training labels for use by the machine learning model.

7. The system as recited in claim 6, wherein the computer executable instructions are configured for execution by the processor to cause the processor to train a target discriminator using multiple-instance learning.

8. The system as recited in claim 1, wherein the plurality of candidate targets comprises at least one gene associated with a crop performance or a trait of an agricultural product.

9. The system as recited in claim 8, wherein the agricultural product comprises at least one of soybean or yellow pea.

10. The system as recited in claim 1, wherein the plurality of candidate targets comprises at least one gene associated with an increase or enhancement of at least one of a protein content, a flavor, or a nutrition of the agricultural product.

11. The system as recited in claim 1, wherein the plurality of candidate targets comprises at least one gene associated with at least one of male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, or modified water use efficiency.

12. The system as recited in claim 1, wherein the plurality of candidate targets comprises at least one gene associated with a deleterious trait.

13. A non-transitory computer-readable storage medium having computer executable instructions configured to generate training data for a machine learning target prioritization model, the computer executable instructions comprising:
receiving, by a processor, a plurality of rules linking a plurality of candidate targets to a goal, at least one rule of the plurality of rules being at least one of incomplete, biased, or partially incorrect;
generating, by the processor, a plurality of voters, each one of the plurality of voters associated with a corresponding one of the plurality of rules, each one of the plurality of voters containing logic of each corresponding one of the plurality of rules;
assigning, by the processor, via each one of the plurality of voters, at least one of an association value or an abstention to each one of the plurality of candidate targets;
creating, by the processor, a single training label for each one of the plurality of candidate targets having at least one association value by combining the association values assigned to each respective one of the plurality of candidate targets; and
furnishing, by the processor, the plurality of candidate targets and associated single training labels for use by a machine learning model.

14. The non-transitory computer-readable storage medium having computer executable instructions as recited in claim 13, wherein the plurality of rules is generated at least one of heuristically or algorithmically.

15. The non-transitory computer-readable storage medium having computer executable instructions as recited in claim 13, wherein the plurality of rules is generated using all available data linking the plurality of candidate targets to the goal.

16. The non-transitory computer-readable storage medium having computer executable instructions as recited in claim 13, wherein the association value is positive and unlabeled.

17. The non-transitory computer-readable storage medium having computer executable instructions as recited in claim 13, wherein the association value is either positive or negative.

18. The non-transitory computer-readable storage medium having computer executable instructions as recited in claim 13, further comprising furnishing, by the processor, at least one loci subset associated with the plurality of candidate targets along with the plurality of candidate targets and associated single training labels for use by the machine learning model.

19. The non-transitory computer-readable storage medium having computer executable instructions as recited in claim 18, further comprising training, by the processor, a target discriminator using multiple-instance learning.

20. The non-transitory computer-readable storage medium having computer executable instructions as recited in claim 13, wherein the plurality of candidate targets comprises at least one gene associated with a crop performance or a trait of an agricultural product.

21. The non-transitory computer-readable storage medium having computer executable instructions as recited in claim 20, wherein the agricultural product comprises at least one of soybean or yellow pea.

22. The non-transitory computer-readable storage medium having computer executable instructions as recited in claim 13, wherein the plurality of candidate targets comprises at least one gene associated with an increase or enhancement of at least one of a protein content, a flavor, or a nutrition of the agricultural product.

23. The non-transitory computer-readable storage medium having computer executable instructions as recited in claim 13, wherein the plurality of candidate targets comprises at least one gene associated with at least one of male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, or modified water use efficiency.

24. The non-transitory computer-readable storage medium having computer executable instructions as recited in claim 13, wherein the plurality of candidate targets comprises at least one gene associated with a deleterious trait.

25. A system for generating training data for a machine learning target prioritization model, the system comprising:
a processor; and
a memory having computer executable instructions stored thereon, the computer executable instructions configured for execution by the processor to:
cause the processor to create or receive a single training label for each one of a plurality of candidate targets,
cause the processor to receive at least one loci subset associated with the plurality of candidate targets, and
cause the processor to furnish the at least one loci subset associated with the plurality of candidate targets along with the plurality of candidate targets and associated single training labels for use by a machine learning model.

26. The system as recited in claim 25, wherein causing the processor to create or receive the single training label for each one of the plurality of candidate targets comprises:
causing the processor to receive a plurality of rules linking the plurality of candidate targets to a goal, at least one rule of the plurality of rules being at least one of incomplete, biased, or partially incorrect,
causing the processor to generate a plurality of voters, each one of the plurality of voters associated with a corresponding one of the plurality of rules, each one of the plurality of voters containing logic of each corresponding one of the plurality of rules,
causing the processor to assign, via each one of the plurality of voters, at least one of an association value or an abstention to each one of the plurality of candidate targets, and
causing the processor to create the single training label for each one of the plurality of candidate targets having at least one association value by combining the association values assigned to each respective one of the plurality of candidate targets.

27. The system as recited in claim 26, wherein the plurality of rules is generated at least one of heuristically or algorithmically.

28. The system as recited in claim 26, wherein the plurality of rules is generated using all available data linking the plurality of candidate targets to the goal.

29. The system as recited in claim 26, wherein the association value is positive and unlabeled.

30. The system as recited in claim 26, wherein the association value is either positive or negative.

31. The system as recited in claim 25, wherein the computer executable instructions are configured for execution by the processor to cause the processor to train a target discriminator using multiple-instance learning.

32. The system as recited in claim 25, wherein the plurality of candidate targets comprises at least one gene associated with a crop performance or a trait of an agricultural product.

33. The system as recited in claim 32, wherein the agricultural product comprises at least one of soybean or yellow pea.

34. The system as recited in claim 25, wherein the plurality of candidate targets comprises at least one gene associated with an increase or enhancement of at least one of a protein content, a flavor, or a nutrition of the agricultural product.

35. The system as recited in claim 25, wherein the plurality of candidate targets comprises at least one gene associated with at least one of male sterility, herbicide tolerance, pest tolerance, disease tolerance, modified fatty acid metabolism, modified carbohydrate metabolism, modified seed yield, modified seed oil, modified seed protein, modified lodging resistance, modified shattering, modified iron-deficiency chlorosis, or modified water use efficiency.

36. The system as recited in claim 25, wherein the plurality of candidate targets comprises at least one gene associated with a deleterious trait.
